(19) United States
(12) Patent Application Publication
(10) Pub. No.: US 2020/0309499 A1
(43) Pub. Date: Oct. 1, 2020

(54) Skate Blade Flatness Gage

(71) Applicant: Michael William Hauer, Brooklyn, MI (US)

(72) Inventor: Michael William Hauer, Brooklyn, MI (US)

(21) Appl. No.: 16/371,024

(22) Filed: Mar. 31, 2019

(51) Int. Cl. G01B 5/00; G01B 5/28

(52) U.S. Cl. CPC G01B 5/0023; G01B 5/285

(57) ABSTRACT

A system for quickly determining if a hockey skate blade is bent is disclosed. The system is a quick and effective way to determine if a Hockey Skate Blade is bent which will affect the ability for the blade to be sharpened and skating performance. The disclosed system is a simple way to ensure skating performance and blade sharpness are optimized.

### FIELD OF INVENTION

The technology relates to the general field of the sport of hockey, and has certain specific application to hockey skate blades.

### BACKGROUND

Hockey skate blades originally were thicker and had a metal holder for support of the blade. The technology evolved and they went to a plastic holder and a thinner blade made from hard carbon steel. The next stage was a plastic holder and a blade made from stainless steel. The carbon steel blades had a tendency to break while stainless steel has a tendency to bend when impacted.

### SUMMARY

The disclosed Skate Blade Flatness Gage will check a Hockey Skate Blade to see if it is bent to the point it will affect skating performance and ability to be sharpened effectively.

It may be used by hockey skate sharpening professionals, personal skate blade sharpeners, hockey equipment managers, coaches and hockey players.

### BRIEF DESCRIPTION OF THE DRAWINGS

Various embodiments of the invention are disclosed in the following detailed description and accompanying drawings.

FIG. 1 illustrates an isometric view of the Skate Blade Flatness Gage.

FIG. 2 illustrates a front view of the Skate Blade Flatness Gage.

FIG. 3 is a picture of the prototype Skate Blade Flatness Gage.

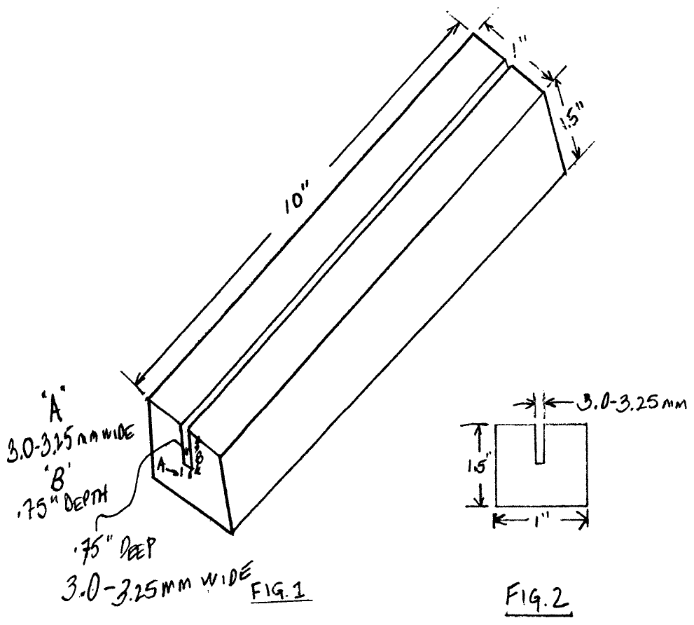

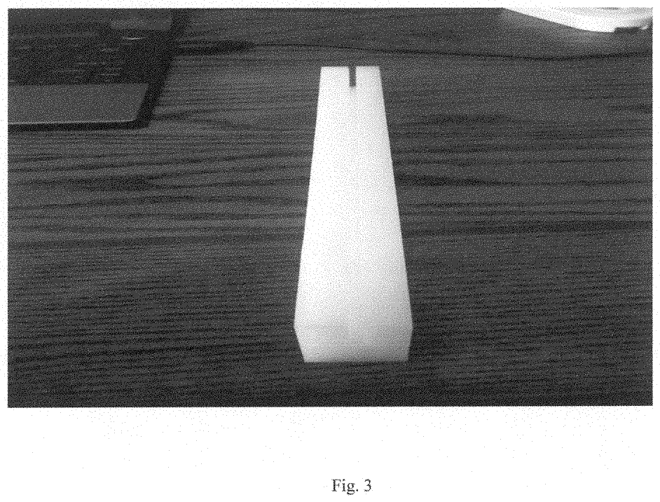

### DETAILED DESCRIPTION

A current hockey skate blade is made from multiple grades of steel and is 2.9 mm thick.

The Skate Blade Flatness Gage is a go/no go gage where by the skate blade is either pressed into the slot from the top or inserted to the slot from the front to the back or back to the front. If any resistance is felt inserting the whole blade into the slot from any direction then the blade is bent and needs to be replaced.

It is made of any material with a 3.0-3.3 mm gap that is ¾″ deep. The block is (3″ to 20″ long)×1.5″ high×1″ wide. The Skate Blade Flatness Gage can be made from plastic, wood, metal, composites or any solid material. This product is made from Nylon for cost effectiveness and heat stability. The prototype Gage is made at a length of 10″ with a 1.5″ height and 1″ width to fit a majority of hockey skate blade lengths and be cost effective. It can be made of multiple lengths, widths and heights to cover specific blade lengths if necessary.

The slot is cut from 3.0 mm to 3.25 mm wide for general use. The slot can be made at down to 2.9 mm for a more exact flatness gage but most blades have a slight bend from manufacturing. This would result in most blades not fitting into the slot. The depth of the slot can be of any depth to ensure the whole depth of the skate blade goes into the slot. The blade holder needs to bottom out in the slot to ensure the whole blade is checked for flatness.

The block is inserted on to the skate blade in either of two ways:
1. By sliding the skate blade through the gap in the block horizontally from front to back or back to front.
2. By placing the block gap onto the skate blade vertically.

If the block slides horizontally with resistance or cannot be applied vertically, the skate blade is bent and must be replaced.

### CONCLUSION

The disclosed embodiments are illustrative, not restrictive. While specific configurations of the Skate Blade Flatness Gage have been described, it is understood that the present invention can be applied to a wide variety of skating blades. There are many alternative ways of implementing the invention.

1. This is a simple go/no go gage to determine if a hockey skate blade is bent to the point it will impair skating performance.

2. This is a simple go/no go gage to determine if a hockey skate blade is bent to the point it will impair ability to properly sharpen the blade.
